(19) United States
(12) Patent Application Publication
(10) Pub. No.: US 2009/0061311 A1
(43) Pub. Date: Mar. 5, 2009

(54) Non-aqueous electrolyte secondary battery

(76) Inventors: Masaharu Itaya, Hyogo (JP); Atsushi Fukui, Hyogo (JP); Shouichirou Sawa, Tokushima (JP); Yasuyuki Kusumoto, Hyogo (JP); Masahisa Fujimoto, Osaka (JP)

Correspondence Address: KRATZ, QUINTOS & HANSON, LLP, 1420 K Street, N.W., Suite 400, WASHINGTON, DC, 20005, US

(21) Appl. No.: 11/887,144

(22) PCT Filed: Feb. 3, 2006
(86) PCT No.: PCT/JP2006/301843

§ 371 Date: Sep. 26, 2007

(30) Foreign Application Priority Data
Mar. 29, 2005 (JP) 2005-095091

(51) Int. Cl. H01M 4/62; H01M 6/04

(52) U.S. Cl. 429/199; 429/218.1; 429/217

(57) ABSTRACT

An object of the invention is to provide a non-aqueous electrolyte secondary battery that allows a good charge/discharge cycle characteristic to be obtained. The non-aqueous electrolyte secondary battery according to the invention includes a negative electrode containing silicon as a negative electrode active material, a positive electrode, and a non-aqueous electrolyte, the average particle size of the negative electrode active material is not less than 5 μm nor more than 20 μm, and the weight of the negative electrode active material is at least 10% of the weight of the non-aqueous electrolyte.

### TECHNICAL FIELD

The present invention relates to a non-aqueous electrolyte secondary battery including a positive electrode, a negative electrode, and a non-aqueous electrolyte.

### BACKGROUND ART

In recent years, non-aqueous electrolyte secondary batteries have been in wide use as secondary batteries with high energy density, in which a non-aqueous electrolyte is used, and for example, lithium ions are transferred between a positive electrode and a negative electrode to carry out charge and discharge.

Such a non-aqueous electrolyte secondary battery is used as a power supply for various portable devices, and as the portable devices have gained increased functions, the power consumption has increased. Therefore, today, there has been a strong demand for a non-aqueous electrolyte secondary battery that allows even higher energy density to be obtained.

An effective measure to increase the energy density is to use a material having a greater energy density as an active material for electrodes.

Recently, instead of graphite that has been in use today, the use of an alloy material containing aluminum (Al), tin (Sn), silicon (Si) or the like that stores lithium ions by alloying reaction for a negative electrode active material having higher energy density has been suggested (see for example Patent Document 1).

[Patent Document 1] International Publication No. 2004-004031 pamphlet

### DISCLOSURE OF THE INVENTION

### Problems to be Solved by the Invention

In a conventional non-aqueous electrolyte secondary battery including a negative electrode containing silicon as the negative electrode active material, however, the surface of the negative electrode active material is cracked by the expansion and shrinkage of the negative electrode active material during storage and release of lithium ions, which degrades the negative electrode active material. Consequently, the non-aqueous electrolyte is excessively absorbed to the negative electrode and a dry-out state is generated in the positive electrode. This prevents a good charge/discharge cycle characteristic from being obtained.

An effective measure to increase the energy density is to reduce the amount of the non-aqueous electrolyte as much as possible, and when a negative electrode active material of silicon is used in general, it is believed that the weight of the negative electrode active material is preferably 10% or more of the weight of the non-aqueous electrolyte.

However, if the weight of the negative electrode active material is 10% or more of the weight of the non-aqueous electrolyte, the dry-out state described above is remarkably caused, which even more degrades the charge/discharge cycle characteristic.

It is an object of the invention to provide a non-aqueous electrolyte secondary battery that allows a good charge/discharge cycle characteristic to be obtained.

### Means for Solving the Problems

A non-aqueous electrolyte secondary battery according to one aspect of the invention includes a negative electrode containing silicon as a negative electrode active material, a positive electrode, and a non-aqueous electrolyte, the average particle size of the negative electrode active material is not less than 5 μm nor more than 20 μm, and the weight of the negative electrode active material is at least 10% of the weight of the non-aqueous electrolyte.

In general, the expansion and shrinkage of the negative electrode active material during storage and release of lithium ions causes cracks at the surface of the negative electrode active material, which degrades the negative electrode active material. The use of a negative electrode active material having a small average particle size causes the total surface area of the degraded negative electrode active material particles to be increased. Consequently, the non-aqueous electrolyte is excessively absorbed to the negative electrode and a dry-out state is generated in the positive electrode.

In the non-aqueous electrolyte secondary battery according to the invention, the negative electrode active material having an average particle size of not less than 5 μm nor more than 20 μm is used, so that the total surface area of the degraded negative electrode active material particles can be reduced.

Furthermore, the number of contacts in the negative electrode active material having an average particle size in the range from 5 μm to 20 μm is smaller than that in the negative electrode active material having an average particle size less than 5 μm, and therefore the contact resistance between the particles of the negative electrode active material is lowered. This equalizes the above-described expansion and shrinkage of the negative electrode active material, and cracking in the negative electrode active material is reduced.

Therefore, if the weight of the negative electrode active material is at least 10% of the weight of the non-aqueous electrolyte, a non-aqueous electrolyte secondary battery having a good charge/discharge cycle characteristic can be obtained.

In addition, using the negative electrode active material having an average particle size from 5 μm to 20 μm, a reduction in the current collecting capability that would otherwise be caused using the negative electrode active material having a particle size of at least 20 μm because of the decomposition of the binder can be prevented or restrained.

The non-aqueous electrolyte secondary battery may further include carbon dioxide, and the weight of the carbon dioxide may be not more than 3.7% of the weight of the negative electrode active material.

In this way, the weight of the carbon dioxide contained in the non-aqueous electrolyte secondary battery is not more than 3.7% of the weight of the negative electrode active material, so that a good charge/discharge cycle characteristic can be obtained.

The ratio of the theoretical capacity of the positive electrode relative to the theoretical capacity of the negative electrode may be not more than 1.2.

In this way, the above-described expansion and shrinkage of the negative electrode active material is alleviated, so that the negative electrode active material can be prevented from being degraded. In addition, a metal can be prevented from being precipitated in the negative electrode, and therefore improved safety is secured.

The negative electrode may include a negative electrode mixture containing the negative electrode active material and a binder and a negative electrode collector having the negative electrode mixture formed on a surface thereof. In this way, the negative electrode mixture is easily formed on the negative electrode collector.

The negative electrode mixture may be formed on the negative electrode collector by sintering. In this way, the adhesion between the negative electrode collector and the particles of the negative electrode active material contained in the negative electrode mixture is greatly improved.

The arithmetic mean roughness of the surface of the negative electrode collector may be at least 0.27 μm. In this way, the binder is allowed to come into the irregular part of the surface of the negative electrode collector, so that an anchoring effect (entanglement effect) is generated between the negative electrode collector and the binder. This allows high adhesion to be achieved between the negative electrode collector and the negative electrode mixture.

Using the negative electrode collector having the arithmetic mean roughness as described above, the area of contact between the particles of the negative electrode active material and the surface of the negative electrode collector increases. Therefore, when a negative electrode produced by sintering the negative electrode mixture on the negative electrode collector is used and the above-described sintering is effectively carried out, the adhesion between the negative electrode collector and the particles of the negative electrode active material is more greatly improved.

In this way, when the volume of the negative electrode active material expands and shrinks in association with the storage and release of lithium ions, the layer of the negative electrode mixture can be kept from being separated from the negative electrode collector, so that a good charge/discharge cycle characteristic can be obtained.

The binder may remain after the sintering. In this way, the binder remains rather than being completely decomposed after the sintering, so that the adhesion between the particles of the negative electrode active material and the negative electrode collector and the adhesion between the negative electrode active materiel particles are both improved, and the binding capability of the remaining binder further improves the adhesion.

In this way, if the volume of the negative electrode active material expands and shrinks during the storage and release of lithium ions, the current collecting capability in the negative electrode can be kept from being lowered, so that a good charge/discharge characteristic can be obtained.

The binder may contain polyimide. In this way, the polyimide has high mechanical strength as well as elasticity, and therefore the strength of the negative electrode mixture is maintained despite the expansion and shrinkage of the negative electrode active material in association with the storage and release of lithium ions during charge and discharge. The negative electrode mixture is deformed in conformity with the deformation of the negative electrode active material. Therefore, the current collecting capability can be prevented or restrained from being lowered because of the decomposition of the binder.

The non-aqueous electrolyte may contain lithium hexafluorophosphate. In this way, improved safety is secured.

### EFFECTS OF THE INVENTION

According to the invention, a good charge/discharge cycle characteristic can be obtained, and the current collecting capability can be prevented or restrained from being lowered because of the decomposition of the binder included in the negative electrode.

### BRIEF DESCRIPTION OF THE DRAWINGS

FIG. 1(a) is a schematic view of a non-aqueous electrolyte secondary battery according to an embodiment, and FIG. 1(b) is a sectional view of the non-aqueous electrolyte secondary battery shown in (a) taken along line A-A.

FIG. 2 is a graph showing the relation between the number of cycles and the average particle size of the negative electrode active material when the specific discharge capacity maintenance ratio is 60%.

### BEST MODE FOR CARRYING OUT THE INVENTION

A non-aqueous electrolyte secondary battery according to an embodiment of the invention will be described in conjunction with the accompanying drawings.

The non-aqueous electrolyte secondary battery according to the embodiment includes a positive electrode, a negative electrode, and a non-aqueous electrolyte.

Note that the materials, and the thickness, the concentrations, the densities and the like of the materials are not limited to those in the following description and may be set as required.

[Manufacture of Negative Electrode]

Slurry as a negative electrode mixture is produced by mixing 9.1% by weight of a mixture containing 90 parts by weight of silicon powder (purity: 99.9%) having an average particle size from 5 μm to 20 μm as a negative electrode active material and 10 parts by weight of polyimide as a binder with a solution of N-methyl-2-pyrrolidone and xylene mixed in a ratio of 90:10 by volume.

The negative electrode mixture produced in this way is applied on a negative electrode collector of a metal foil having an arithmetic mean roughness Ra from 0.27 μm to 10 μm and a thickness of 35 μm, and then dried in a temperature environment at 120° C. In this example, an electrolytic copper foil is used as the metal foil.

The dried negative electrode mixture is rolled and then sintered for one to ten hours in an argon containing environment at 400° C. in order to form a negative electrode.

Note that the arithmetic mean roughness Ra is a parameter representing a surface roughness defined by Japanese Industrial Standards (JIS B 0601-1994) and can be measured using for example a stylus type surface roughness meter.

The above-described binder for the negative electrode preferably has high mechanical strength because it is preferable that the strength of the negative electrode mixture is maintained despite the expansion and shrinkage of the negative electrode active material caused by storage and release of lithium ions during charge and discharge, and the negative electrode mixture is deformed in conformity with the deformation of the negative electrode active material. It is particularly preferable that the binder has high elasticity. An example of such a binder is the polyimide described above.

As an example of a method of obtaining polyimide, polyamic acid may be thermally treated. The thermal treatment causes the polyamic acid to undergo dehydrating condensation, so that polyimide is generated.

According to the embodiment, a negative electrode mixture containing polyamic acid as a precursor may be provided on the negative electrode collector, and then the negative electrode mixture may be thermally treated, so that polyimide as the binder may be produced.

If the negative electrode mixture is provided on the negative electrode collector by sintering, the thermal treatment for dehydrating condensation of the polyamic acid after the negative mixture is provided may be carried out also as thermal treatment for the above-described sintering, so that the polyimide as the binder may be produced.

The imidization ratio of polyimide is preferably not less than 80%. If polyimide having an imidization ratio of less than 80% is used, particles of the negative electrode active material may not adhere closely enough to the negative electrode collector in some cases.

Here, the imidization ratio refers to the molar ratio (%) of generated polyimide relative to the polyimide precursor.

The polyimide having an imidization ratio of 80% or more can be obtained by thermally treating a N-methyl-pyrrolidone solution containing polyamic acid at a temperature in the range from 100° C. to 400° C. for one hour or more. Note that if the N-methyl-pyrrolidone solution containing polyamic acid is thermally treated at 350° C., the imidization ratio is 80% after a treatment period of about one hour, and 100% after a treatment period of about three hours.

The weight of the binder for the negative electrode is preferably at least 5% of the total weight of the negative electrode mixture, and the volume of the binder for the negative electrode is preferably at least 5% of the total volume of the negative electrode mixture. Here, the total volume of the negative electrode mixture refers to the total sum of the volumes of the negative electrode active material and the binder contained in the layer of the negative electrode mixture and if there is voids within the layer, the volume of the voids is not included.

If the weight of the binder for the negative electrode is less than 5% of the total weight of the negative electrode mixture, or if the volume is less than 5% of the total volume of the negative electrode mixture, the amount of the binder is not sufficient for the particles of the negative electrode active material. As a result, sufficient adhesion by the binder is not obtained in the negative electrode.

On the other hand, if the amount of the binder in the negative electrode is excessive, the resistance in the negative electrode increases, and therefore it is difficult to carry out initial charge.

Therefore, the amount of the binder in the negative electrode is more preferably in the range from 5% to 50% of the total weight of the negative electrode mixture, and the volume of the binder in the negative electrode is more preferably in the range from 5% to 50% of the total volume of the negative electrode mixture.

If a negative electrode produced by sintering the negative electrode mixture on the negative electrode collector is used, a binder that can remain rather than being completely decomposed after the thermal treatment for the sintering is preferably used.

If the binder remains without being completely decomposed after the thermal treatment, the adhesion between the particles of the negative electrode active material and the negative electrode collector and the adhesion among the negative electrode active materiel particles are both improved, and the binding capability of the remaining binder also improves the adhesion.

In this way, if the volume of the negative electrode active material expands and shrinks during the storage and release of lithium ions, the current collecting capability in the negative electrode can be kept from being lowered, so that a good charge/discharge cycle characteristic can be obtained.

As described above, the binder preferably remains rather than being completely decomposed after the thermal treatment, and therefore if polyimide is used as the binder for the negative electrode, the thermal treatment for sintering is preferably carried out at a temperature of 500° C. or less at which polyimide is not completely decomposed, more preferably at a temperature in the range from 200° C. to 500° C., even more preferably in the range from 300° C. to 450° C.

According to the embodiment, silicon is particularly preferably applied as a negative electrode active material, while a silicon alloy may be used as well.

Examples of the silicon alloy may include a solid solution of silicon and at least another element, an intermetallic compound of silicon and at least another element, and a eutectic alloy of silicon and at least another element.

Examples of a method of producing such a silicon alloy may include arc melting, liquid quenching, mechanical alloying, sputtering, chemical vapor deposition, and sintering. More specifically, examples of the liquid quenching may include single-roll quenching, double-roll quenching, and various kinds of atomization methods such as gas atomization, water atomization, and disk atomization.

The silicon alloy may be produced by coating the particle surface of silicon and/or a silicon alloy with a metal or the like. Examples of the coating method may include electroless plating, electroplating, chemical reduction, vapor deposition, sputtering, and chemical vapor deposition.

Now, why it is preferable to use the negative electrode collector made of a metal foil having an arithmetic mean roughness Ra in the range from 0.27 μm to 10 μm as described above will be described.

The use of the negative electrode collector of the metal foil having the arithmetic mean roughness Ra as described above allows the binder to come into the irregular part of the surface of the negative electrode collector, so that an anchoring effect (entanglement effect) is generated between the negative electrode collector and the binder. This allows high adhesion to be achieved between the negative electrode collector and the negative electrode mixture.

Using the negative electrode collector of the metal foil having the arithmetic mean roughness Ra as described above, the area of contact between the particles of the negative electrode active material and the surface of the negative electrode collector increases. Therefore, when a negative electrode produced by sintering the negative electrode mixture on the negative electrode collector is used and the above-described sintering is effectively carried out, the adhesion between the negative electrode collector and the particles of the negative electrode active material is further greatly improved.

In this way, if the volume of the negative electrode active material expands and shrinks in association with the storage and release of lithium ions, the layer of the negative electrode mixture can be kept from being separated from the negative electrode collector, so that a good charge/discharge cycle characteristic can be obtained. Note that if a layer of the negative electrode mixture is formed on both surfaces of the negative electrode collector, the arithmetic mean roughness Ra of the negative electrode collector is preferably from 0.27 μm to 10 μm.

The relation between the arithmetic mean roughness Ra and the average interval S, i.e., the average space between adjacent local peaks preferably satisfies 100 Ra≧S. Note that the average interval S is defined by Japanese Industrial Standards (JIS B 0601-1994) and is measured using for example a stylus type surface roughness meter.

In order to obtain a negative electrode collector having an arithmetic mean roughness Ra in the range from 0.27 μm to 10 μm, the negative electrode collector may be subjected to roughening processing.

Examples of the roughening processing may include plating, vapor deposition, etching, and polishing techniques. According to the plating and vapor deposition techniques, the negative electrode collector is provided with a thin film layer having an irregular part on its surface for roughening.

Examples of the plating technique may include electroplating and electroless plating. Examples of the vapor deposition may include sputtering, chemical vapor deposition, and vapor deposition.

Examples of the etching technique may include physical etching and chemical etching. Examples of the polishing technique may include polishing with sandpaper and polishing by blasting.

According to the embodiment, the thickness of the negative electrode collector is preferably in the range from 10 μm to 100 μm though not specifically limited to the range.

According to the embodiment, as the negative electrode collector, a metal such as copper, nickel, iron, titanium, or cobalt or an alloy including a combination of these metals may be used.

If the negative electrode collector is produced by sintering the negative electrode mixture on the negative electrode collector, the negative electrode collector may preferably include a metal element that can easily be dispersed within the negative electrode active material. An example of the material of the negative electrode collector may include a metal foil containing copper, particularly a copper foil, or a copper alloy foil. The thermal treatment for the sintering allows the copper to be more easily dispersed within the negative electrode active material. In this way, improved adhesion between the negative electrode active material and the negative electrode collector is expected.

For the purpose of improving the adhesion between the negative electrode active material and the negative electrode collector by the above-described sintering, it is only necessary to use a metal foil having a layer containing copper on its surface in contact with the negative electrode active material as the negative electrode collector. Alternatively, the negative electrode collector having a layer of copper or a copper alloy formed on a metal foil of a metal element other than copper may be used.

An example of a method of forming such a layer of copper or a copper alloy having an arithmetic mean roughness Ra in the range from 0.27 μm to 10 μm on the metal foil is an electroplating technique.

Examples of a plating layer formed on a metal foil by the electroplating may include an electrolytic copper foil formed by plating a copper foil with a copper plating film and a copper plating film formed on a nickel foil.

According to the embodiment, when the thickness of the layer of the negative electrode mixture is X and the thickness of the negative electrode collector of the metal foil is Y, the relation represented by 5Y≧X and 250Ra≧X is preferably satisfied. Note that the Ra in the relation represents the above-described arithmetic mean roughness.

If the above-described relation is not satisfied, in other words, if X is greater than 5Y or X is greater than 250Ra, the degree of expansion and shrinkage of the volume of the layer of the negative electrode mixture during charge and discharge increases, and the adhesion between the layer of the negative electrode mixture and the negative electrode collector is no longer maintained by the irregularities of the surface of the negative electrode collector. Consequently, the layer of the negative electrode mixture is sometimes removed from the negative electrode collector.

The thickness X of the layer of the negative electrode mixture is preferably not more than 1000 μm, more preferably from 10 μm to 100 μm though not specifically limited to the range.

According to the embodiment, if the negative electrode produced by sintering the negative electrode mixture on the negative electrode collector is used, the sintering processing is preferably carried out in vacuum, in a nitrogen atmosphere or in an inert gas atmosphere such as an argon atmosphere. The sintering processing may be carried out in a reductive atmosphere such as a hydrogen atmosphere. The sintering processing may be carried out in an oxidizing atmosphere such as in the air, and in this case, the temperature for the thermal treatment for the sintering is preferably not more than 300° C., and spark plasma sintering or hot pressing may be employed as a method of processing for the sintering.

[Manufacture of Positive Electrode]

As starting materials, Li₂CO₃ and CoCO₃ are mixed in a mortar while their amounts are weighed so that the atomic ratio between lithium and cobalt is 10:10.

The mixture is pressed using a die, molded under pressure, and then sintered in a temperature environment at 800° C. for 24 hours in an air atmosphere, so that LiCoO₂ in a sintered state is obtained.

The sintered substance is ground using a mortar for preparation, so that LiCoO₂ as a positive electrode active material having an average particle size of 20 μm is obtained.

Slurry as a positive electrode mixture is produced by mixing 94 parts by weight of the LiCoO₂ powder and 3 parts by weight of artificial graphite powder as a conductive agent in a 6 wt % N-methyl-2-pyrrolidone solution containing 3 parts by weight of polyvinylidene fluoride as a binder.

The thus obtained positive electrode mixture is applied on one surface of an aluminum foil as a positive electrode collector, dried, and then rolled, so that a positive electrode is produced. Note that the thickness of the positive electrode containing a positive electrode collector is for example 155 μm.

According to the embodiment, examples of the positive electrode active material that can be used instead of LiCoO₂ may include a lithium-containing transition metal oxide such as LiNiO₂, LiCoO₂, LiMn₂O₄, LiMnO₂, LiCo_{0.5}Ni_{0.5}O₂, and LiNi_{0.7}C_{0.2}Mn_{0.1}O₂, and a metal oxide that does not contain lithium such as MnO₂. Alternatively, any other material capable of electrochemically storing and releasing lithium ions may be used as the above-described positive electrode active material.

According to the embodiment, another fluoride-based polymer or polyimide may be used as the binder for the positive electrode instead of polyvinylidene fluoride.

[Manufacture of Non-Aqueous Electrolyte]

A non-aqueous electrolyte may be produced by dissolving an electrolyte salt in a non-aqueous solvent.

Examples of the non-aqueous solvent may include a cyclic carbonate, a chain carbonate, esters, cyclic ethers, chain ethers, nitrites, amides, and a combination thereof, which are typically used as a non-aqueous solvent for a battery.

Examples of the cyclic carbonate may include ethylene carbonate, propylene carbonate, butylene carbonate, and any of the above having its hydrogen group partly or entirely fluorinated such as trifluoropropylene carbonate and fluoroethyl carbonate.

Examples of the chain carbonate may include dimethyl carbonate, ethyl methyl carbonate, diethyl carbonate, methyl propyl carbonate, ethyl propyl carbonate, methyl isopropyl carbonate, and any of the above having its hydrogen group partly or entirely fluorinated.

Examples of the esters may include methyl acetate, ethyl acetate, propyl acetate, methyl propionate, ethyl propionate, and γ-butyrolactone. Examples of the cyclic ethers may include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and a crown ether.

Examples of the chain ethers may include 1,2-dimethoxyethane, diethyl ether, dipropyl ether, diisopropyl ether, dibutyl ether, dihexyl ether, ethyl vinyl ether, butyl vinyl ether, methylphenyl ether, ethylphenyl ether, butylphenyl ether, pentylphenyl ether, methoxytoluene, benzylethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, trienthylene glycol dimethyl ether, and tetraethylene glycol dimethyl.

An example of the nitriles may include acetonitrile, and an example of the amides may include dimethylformamide.

Examples of the electrolyte salt may include lithium hexafluorophosphate (LiPF₆), lithium tetrafluoroborate (LiBF₄), LiCF₃SO₃, LiC₄F₉SO₃, LiN(CF₃SO₂)₂, LiN(C₂F₅SO₂)₂, LiAsF₆, LiN(CF₃SO₂) (C₄F₉SO₂), LiC(CF₃SO₂)₃, LiC(C₂F₅SO₂)₃, LiClO₄, Li₂B₁₀Cl₁₀, and Li₂B₁₂Cl₁₂, and a mixture thereof.

In the embodiment, it is particularly preferable to use, as the electrolyte salt, LiXF_{y}, lithium perfluoroalkyl sulfonyl amide (LiN(CₘF₂ₘ₊₁SO₂)(CₙF₂ₙ₊₁SO₂)) or lithium perfluoroalkyl sulfonyl methid (LiC(CₚF₂ₚ₊₁SO₂) (C_{q}F_{2q+1}SO₂) (CᵣF₂ᵣ₊₁SO₂)).

Note that the above-described X is phosphorus (P), arsenic (As), antimony (Sb), boron (B), bismuth (Bi), aluminum (Al), gallium (Ga) or indium (In).

If the above-described X is phosphorus, arsenic, or antimony, the above-described y is 6, while if the above-described X is boron, bismuth, aluminum, gallium or indium, the above y is 4.

The above m and n are each an independent integer from 1 to 4, and the above p, q, and r are each an independent integer from 1 to 4.

According to the embodiment, the non-aqueous electrolyte is produced by adding lithium hexafluorophosphate as the electrolyte salt in a concentration of 1.0 mol/l to a non-aqueous solvent produced by mixing ethylene carbonate (EC) and diethylcarbonate (DEC) in a ratio of 30:70 by volume. The non-aqueous electrolyte may contain at most 3.7% by weight of carbon dioxide (CO₂) of the non-aqueous electrolyte.

Instead of the non-aqueous electrolyte, a gel-type polymer non-aqueous electrolyte produced by immersing an electrolyte salt of polymer such as polyethylene oxide and polyacrylonitrile with a prescribed non-aqueous solvent or an inorganic solid electrolyte such as LiI and Li₃N may be used.

According to the embodiment, the electrolyte in which a lithium compound as a solute having good ion conductivity and a solvent that dissolves and holds the lithium compound are not decomposed at voltage during charge, discharge, and storage may be used.

[Manufacture of Non-aqueous Electrolyte Secondary Battery]

According to the embodiment, a non-aqueous electrolyte secondary battery as shown in the following paragraphs is produced using the positive electrode, the negative electrode, and the non-aqueous electrolyte described above.

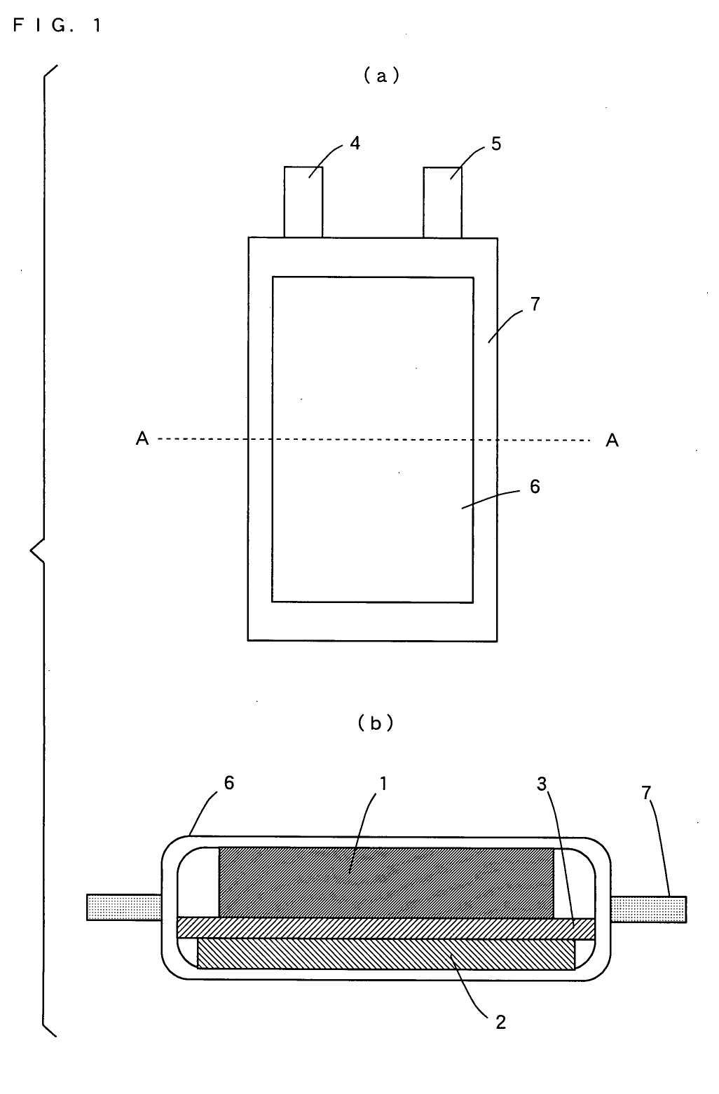

FIG. 1(a) is a schematic view of a non-aqueous electrolyte secondary battery according to the embodiment, and FIG. 1(b) is a sectional view of the non-aqueous electrolyte secondary battery taken along line A-A in FIG. 1(a).

As shown in FIG. 1(a), the non-aqueous electrolyte secondary battery according to the embodiment includes a case body 6 of aluminum laminates.

There is a closed part 7 formed at the time of thermally sealing the ends of the aluminum laminates at the sides of the case body 6.

A positive electrode tab 4 and a negative electrode tab 5 are externally extended from the inside of the case body 6.

As shown in FIG. 1(b), the positive electrode 1, the negative electrode 2, and a separator 3 of a porous polyethylene material are provided in the case body 6.

The positive electrode 1 and the negative electrode 2 are provided to be opposite to each other through the separator 3. The positive electrode 1 and the negative electrode 2 are connected to the positive electrode tab 4 and the negative electrode tab 5, respectively.

### EFFECTS OF EMBODIMENT

As described above, in general, the surface of the negative electrode active material is cracked by the expansion and shrinkage of the negative electrode active material during storage and release of lithium ions, which degrades the negative electrode active material. If a negative electrode active material having a small average particle size is used, the total surface area of the degraded negative electrode active material particles increases. Consequently, the non-aqueous electrolyte is excessively absorbed by the negative electrode, and a dry-out state is generated in the positive electrode.

According to the embodiment, a negative electrode active material having an average particle size in the range from 5 μm to 20 μm is used, so that the total surface area of the degraded negative electrode active material particles can be reduced.

The number of contacts among the negative electrode active material particles having an average particle size in the range from 5 μm to 20 μm is smaller than that in the negative electrode active material particles having an average particle size less than 5 μm, and therefore the contact resistance between the particles of the negative electrode active material is lowered. This equalizes the above-described expansion and shrinkage of the negative electrode active material, and cracking in the negative electrode active material is reduced.

In this way, if the weight of the negative electrode active material is at least 10% of the weight of the non-aqueous electrolyte, a non-aqueous electrolyte secondary battery having a good charge/discharge cycle characteristic can be obtained.

According to the embodiment, the weight of carbon dioxide contained in the non-aqueous electrolyte secondary battery is not more than 3.7% of the weight of the negative electrode active material, so that a good charge/discharge cycle characteristic can be obtained.

Furthermore, according to the embodiment, using a negative electrode active material having an average particle size in the range from 5 μm to 20 μm, a loss in the current collecting capability caused by cracking in the binder or the like that would otherwise be generated using a negative electrode active material having an average particle size of at least 20 μm can be prevented or reduced.

### EXAMPLES

Various kinds of non-aqueous electrolyte secondary batteries as shown in FIG. 1 were produced in accordance with the embodiment described above. The arithmetic mean roughness Ra of the negative electrode collector of each of the non-aqueous electrolyte secondary batteries was 1.49 μm.

The thickness of the negative electrode including the negative electrode collector was 50 μm. As described in conjunction with the embodiment, the thickness of the negative electrode collector of the electrolyte copper foil was 35 μm, and therefore the thickness of the layer of the negative electrode mixture was estimated to be 15 μm. Consequently, the ratio of the layer of the negative electrode mixture relative to the arithmetic mean roughness Ra of the negative electrode collector was 15 and the ratio of the layer of the negative electrode mixture relative to the thickness of the negative electrode collector was 0.43.

The density of polyimide used for the binder for the negative electrode 2 was 1.1 g/cm³ and the volume occupied by the polyimide was 19.1% of the layer of the negative electrode mixture.

Now, the non-aqueous electrolyte secondary batteries in various inventive and comparative examples will be described.

<Non-Aqueous Electrolyte Secondary Batteries According to Inventive Examples 1 to 3>

Positive electrodes 1 in the non-aqueous electrolyte secondary batteries according to Inventive Examples 1 to 3 were produced according to the above-described embodiment.

In the non-aqueous electrolyte secondary battery according to Inventive Example 1, a negative electrode 2 was produced using silicon powder having an average particle size of 5 μm, and a non-aqueous electrolyte was produced by adding lithium hexafluorophosphate in a concentration of 1.0 mol/l to a non-aqueous solvent produced by mixing ethylene carbonate and diethylcarbonate in a ratio of 30:70 by volume.

Note that in the non-aqueous electrolyte secondary battery according to Inventive Example 1, the ratio of the negative electrode active material relative to the non-aqueous electrolyte was 10% by weight.

In Inventive Example 1, the ratio of carbon dioxide contained in the non-aqueous electrolyte secondary battery relative to the negative electrode active material was 3.7% by weight.

In the non-aqueous electrolyte secondary battery according to Inventive Example 2, a negative electrode 2 was produced using silicon powder having an average particle size of 5 μm and a non-aqueous electrolyte was produced by adding lithium hexafluorophosphate in a concentration of 1.0 mol/l to a non-aqueous solvent produced by mixing ethylene carbonate and diethylcarbonate in a ratio of 30:70 by volume.

Note that in the non-aqueous electrolyte secondary battery according to Inventive Example 2, the ratio of the negative electrode active material relative to the non-aqueous electrolyte was 20% by weight.

According to Inventive Example 2, the ratio of carbon dioxide contained in the non-aqueous electrolyte secondary battery relative to the negative electrode active material was 1.9% by weight.

In the non-aqueous electrolyte secondary battery according to Inventive Example 3, a negative electrode 2 was produced using silicon powder having an average particle size of 10 μm and a non-aqueous electrolyte was produced by adding lithium hexafluorophosphate in a concentration of 1.0 mol/l to a non-aqueous solvent produced by mixing ethylene carbonate and diethylcarbonate in a ratio of 30:70 by volume.

Note that in the non-aqueous electrolyte secondary battery according to Inventive Example 3, the ratio of the negative electrode active material relative to the non-aqueous electrolyte was 10% by weight.

According to Inventive Example 3, the ratio of carbon dioxide contained in the non-aqueous electrolyte secondary battery relative to the negative electrode active material was 3.7% by weight.

The conditions for producing the non-aqueous electrolyte secondary batteries according to these inventive examples are given in Table 1.

TABLE 1

| | | | carbon | negative |
|---|---|---|---|---|
| | | | dioxide/ | electrode |
| | | | negative | active |
| | | average | electrode | material/non- |
| | volume ratio & | particle | active | aqueous |
| | concentration | size | material | electrolyte |
| | of EC and DEC | [μm] | [wt %] | [wt %] |
| Inv. Example 1 | EC:DEC = 30:70, | 5 | 3.7 | 10 |
| Inv. Example 2 | 1 mol/l | 5 | 1.9 | 20 |
| Inv. Example 3 | | 10 | 3.7 | 10 |
| Comp. Example 1 | | 3 | 3.7 | 10 |
| Comp. Example 2 | | 3 | 1.9 | 20 |

<Non-Aqueous Electrolyte Secondary Batteries According to Comparative Examples 1 and 2>

Positive electrodes 1 in the non-aqueous electrolyte secondary batteries according to Comparative Examples 1 and 2 were produced according to the above-described embodiment.

In the non-aqueous electrolyte secondary battery according to Comparative Example 1, a negative electrode 2 was produced using silicon powder having an average particle size of 3 μm and a non-aqueous electrolyte was produced by adding lithium hexafluorophosphate in a concentration of 1.0 mol/l to a non-aqueous solvent produced by mixing ethylene carbonate and diethylcarbonate in a ratio of 30:70 by volume.

Note that in the non-aqueous electrolyte secondary battery according to Comparative Example 1, the ratio of the negative electrode active material relative to the non-aqueous electrolyte was 10% by weight.

According to Comparative Example 1, the ratio of carbon dioxide contained in the non-aqueous electrolyte secondary battery relative to the negative electrode active material was 3.7% by weight.

In the non-aqueous electrolyte secondary battery according to Comparative Example 2, a negative electrode 2 was produced using silicon powder having an average particle size of 3 μm and a non-aqueous electrolyte was produced by adding lithium hexafluorophosphate in a concentration of 1.0 mol/l to a non-aqueous solvent produced by mixing ethylene carbonate and diethylcarbonate in a ratio of 30:70 by volume.

Note that in the non-aqueous electrolyte secondary battery according to Comparative Example 2, the ratio of the negative electrode active material relative to the non-aqueous electrolyte was 10% by weight.

According to Comparative Example 2, the ratio of carbon dioxide contained in the non-aqueous electrolyte secondary battery relative to the negative electrode active material was 1.9% by weight.

The conditions for producing the non-aqueous electrolyte secondary batteries according to these comparative examples are given in Table 1 as with the inventive examples.

<Settings for Capacity Ratios>

In order to prevent the negative electrode active material from being degraded by the expansion and shrinkage of the negative electrode active material during storage and release of lithium ions, a positive electrode that satisfies the relation represented by Expression (1) as follows is preferably produced.

Capacity of Positive Electrode (Wp×Cp): Capacity of Negative Electrode (Wn×Cn)=1:1.5 to 3 (1)

Note that in Expression (1), Wp (g/cm²) represents the weight of the positive electrode active material per unit area, and Wn (g/cm²) represents the weight of the negative electrode active material per unit area. In Expression (1), Cp represents the specific capacity of the positive electrode active material and Cn represents the specific capacity of the negative electrode active material.

The expansion and shrinkage of the negative electrode active material is alleviated and the negative electrode active material can be prevented from being degraded by producing the positive electrode so that Expression (1) is satisfied. In the negative electrode, a lithium metal can be prevented from being precipitated, so that improved safety is secured.

Here, the specific charge capacity of the positive electrode active material is about 150 mAh/g when the charge cutoff voltage is 4.2V, but the specific charge capacity of the positive electrode active material changes when the charge cutoff voltage is changed.

Therefore, theoretical capacities are preferably employed as the capacities of the positive and negative electrodes in Expression (1). In this case, the theoretical specific capacity of the positive electrode active material is 273.8 mAh/g and the theoretical capacity of the negative electrode active material is 4195 mAh/g.

The relation represented by the following Expression (2) results by substituting the theoretical specific capacities of the positive electrode material and the negative electrode material for Expression (1).

Theoretical Capacity of Positive Electrode: Theoretical Capacity of Negative Electrode=1.2:1 to 2 (2)

From Expression (2), the ratio of the theoretical capacity of the positive electrode relative to the theoretical capacity of the negative electrode (hereinafter referred to as “capacity ratio”) is preferably from 0.6 to 1.2.

In the inventive examples and the comparative examples, the above-described Wp and Wn were set so that the capacity ratio was from 1.0 to 1.2.

<Charge/Discharge Cycle Tests>

Using the non-aqueous electrolyte secondary batteries produced according to Inventive Examples 1 to 3 and Comparative Examples 1 and 2, charge was carried out with a constant current of 3.5 mAh/cm² in a temperature environment at 25° C. until the charge cutoff voltage reached 4.2 V, and discharge was carried out until the discharge cutoff voltage reached 2.75 V with a constant current of 3.5 mAh/cm².

The non-aqueous electrolyte secondary batteries according to Inventive Examples 1 to 3 and Comparative Examples 1 and 2 were subjected to charge/discharge tests while the charge and discharge process described above was set as one cycle.

The non-aqueous electrolyte secondary batteries according to these examples were measured for the number of cycles when the specific discharge capacity maintenance ratio defined by the ratio of specific discharge capacity during a certain cycle relative to the specific discharge capacity in the first cycle was 80% and 60%.

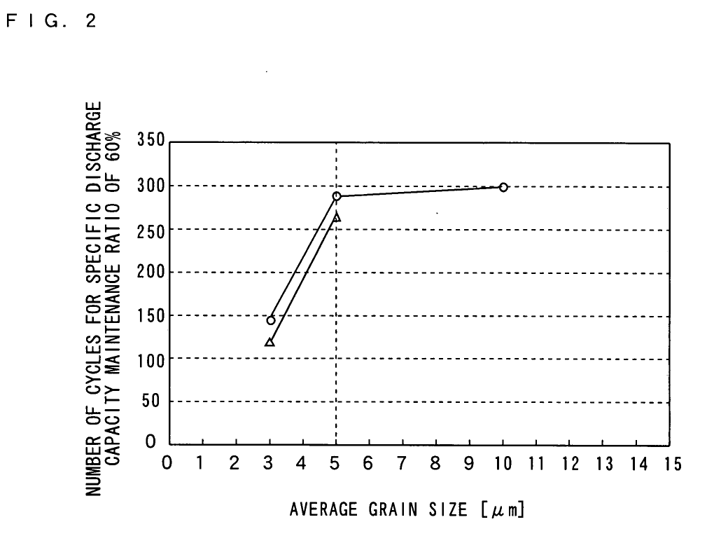

The measurement result is given in Table 2, and the relation between the number of cycles and the average particle size of the negative electrode active material when the specific discharge capacity maintenance ratio is 60% is shown in FIG. 2. In FIG. 2, the case in which the ratio of the negative electrode active material relative to the non-aqueous electrolyte is 10% by weight is denoted by a circle, and the case in which the ratio of the negative electrode active material relative to the non-aqueous electrolyte is 20% by weight is denoted by a triangle.

TABLE 2

| | | negative | number of cycles | |
|---|---|---|---|---|
| | | electrode active | specific | specific |
| | average | material/non- | discharge | discharge |
| | particle | aqueous | capacity | capacity |
| | size | electrolyte | maintenance | maintenance |
| | [μm] | [wt %] | ratio: 80% | ratio: 60% |
| Inv. Example 1 | 5 | 10 | 228 | 287 |
| Inv. Example 2 | 5 | 20 | 202 | 262 |
| Inv. Example 3 | 10 | 10 | 77 | 298 |
| Comp. Example 1 | 3 | 10 | 109 | 145 |
| Comp. Example 2 | 3 | 20 | 80 | 119 |

<Evaluation>

As can be understood from Table 2, the numbers of cycle when the specific discharge capacity maintenance ratios of the non-aqueous electrolyte secondary batteries according to Inventive Examples 1 to 3 were 60% and 80% were larger than the numbers of cycles when the specific discharge capacity maintenance ratios of the non-aqueous electrolyte secondary batteries according to Comparative Examples 1 and 2 were 60% and 80%.

The numbers of cycles when the specific discharge capacity maintenance ratios of the non-aqueous electrolyte secondary batteries according to Inventive Examples 1 to 3 were each 60% in particular were each about twice the number of cycles by each of the non-aqueous electrolyte secondary batteries according to Comparative Examples 1 and 2. It was found that the specific discharge capacities in the charge/discharge cycle tests were maintained in a good level.

As can be understood from FIG. 2, when the average particle size of the negative electrode active material was 5 μm or more, the number of cycles for a specific discharge capacity maintenance ratio of 60% greatly increased.

<Non-Aqueous Electrolyte Secondary Batteries According to Inventive Examples 4 to 7>

In Inventive Example 4, a positive electrode 1 was produced according to the above-described embodiment. A negative electrode 2 was produced according to the embodiment, in which silicon powder having an average particle size of 5 μm was used as the negative electrode active material.

Slurry as the negative electrode mixture containing the silicon powder was applied on a negative electrode collector having an arithmetic mean roughness Ra of 0.36 μm and dried in a temperature environment at 120° C. The dried negative electrode mixture was rolled and then sintered for 10 hours in an argon containing environment at 400° C. to produce a negative electrode.

In Inventive Example 4, a non-aqueous electrolyte was produced by adding lithium hexafluorophosphate in a concentration of 1 mol/l to a non-aqueous solvent produced by mixing ethylene carbonate and diethylcarbonate in a ratio of 30:70 by volume. Note that the above-described non-aqueous electrolyte contains carbon dioxide at most 3.7% by weight of the non-aqueous electrolyte. In the non-aqueous electrolyte secondary battery according to Example 4, the ratio of the negative electrode active material relative to the non-aqueous electrolyte was 20% by weight.

In Inventive Example 5, a non-aqueous electrolyte secondary battery was produced similarly to Inventive Example 4 except that its negative electrode collector had an arithmetic mean roughness Ra of 1.03 μm.

In Inventive Example 6, a non-aqueous electrolyte secondary battery was produced similarly to Inventive Example 4 except that its negative electrode collector had an arithmetic mean roughness Ra of 1.46 μm.

In Inventive Example 7, a non-aqueous electrolyte secondary battery was produced similarly to Inventive Example 4 except that its negative electrode collector had an arithmetic mean roughness Ra of 1.49 μm.

<Non-Aqueous Electrolyte Secondary Battery According to Comparison Example 3>

In Comparison Example 3, a non-aqueous electrolyte secondary battery was produced similarly to Inventive Example 4 except that its negative electrode collector had an arithmetic mean roughness Ra of 0.27 μm.

<Charge/Discharge Cycle Tests>

Using the non-aqueous electrolyte secondary batteries produced in Inventive Examples 4 to 7 and Comparative Example 3, charge was carried out until the charge cutoff voltage reached 4.2 V with a constant current of 3.5 mAh/cm² in a temperature environment at 25° C., and then discharge was carried out until the discharge cutoff voltage reached 2.75 V with a constant current of 3.5 mAh/cm².

While the above-described charge and discharge process was counted as one cycle of charge/discharge test, the non-aqueous electrolyte secondary batteries according to Inventive Examples 4 to 7 and Comparative Example 3 were subjected to charge/discharge tests, and then the specific discharge capacity maintenance ratios were calculated.

The specific discharge capacity maintenance ratios (%) are defined as the ratios of the specific discharge capacity (mAh/g) for the 50th cycle and the 100th cycle to the specific discharge capacity for the first cycle. The calculated specific discharge capacity maintenance ratios are given in Table 3.

TABLE 3

| | arithmetic | specific discharge | |
|---|---|---|---|
| | mean | capacity maintenance ratio | |
| | roughness Ra | [%] | |
| | [μm] | 50th cycle | 100th cycle |
| Inv. Example 4 | 0.36 | 85 | 81 |
| Inv. Example 5 | 1.03 | 80 | 79 |
| Inv. Example 6 | 1.46 | 83 | 82 |
| Inv. Example 7 | 1.49 | 86 | 84 |
| Comp. Example 3 | 0.27 | 78 | 73 |

<Evaluation>

As can be understood from Table 3, using a negative electrode collector having an arithmetic mean roughness Ra of 0.27 μm or more, a good charge/discharge cycle characteristic was obtained.

### INDUSTRIAL APPLICABILITY

The non-aqueous electrolyte secondary battery according to the invention may be applied as various kinds of power supplies such as a portable power supply and an automotive power supply.

1. A non-aqueous electrolyte secondary battery, comprising a negative electrode containing silicon as a negative electrode active material, a positive electrode, and a non-aqueous electrolyte,
said negative electrode active material having an average particle size of not less than 5 μm nor more than 20 μm,
the weight of said negative electrode active material being at least 10% of the weight of said non-aqueous electrolytes,
said battery further comprising carbon dioxide, the weight of said carbon dioxide being not more than 3.7% of the weight of said negative electrode active material.

2. (canceled)

3. The non-aqueous electrolyte secondary battery according to claim 1, wherein the ratio of the theoretical capacity of said positive electrode relative to the theoretical capacity of said negative electrode is not more than 1.2.

4. The non-aqueous electrolyte secondary battery according to claim 1, wherein said negative electrode comprises a negative electrode mixture containing said negative electrode active material and a binder and a negative electrode collector having said negative electrode mixture formed on a surface thereof.

5. The non-aqueous electrolyte secondary battery according to claim 4, wherein said negative electrode mixture is formed on said negative electrode collector by sintering.

6. The non-aqueous electrolyte secondary battery according to claim 4, wherein the arithmetic mean roughness of the surface of said negative electrode collector is at least 0.27 μm.

7. The non-aqueous electrolyte secondary battery according to claim 5, wherein said binder remains after said sintering.

8. The non-aqueous electrolyte secondary battery according to claim 4, wherein said binder contains polyimide.

9. The non-aqueous electrolyte secondary battery according to claim 1, wherein said non-aqueous electrolyte contains lithium hexafluorophosphate.
